(19) United States
(12) Patent Application Publication
(10) Pub. No.: US 2020/0183030 A1
(43) Pub. Date: Jun. 11, 2020

(54) Spectrum Splitting

(71) Applicant: SAExploration Inc., Houston, TX (US)

(72) Inventors: John Stewart Archer, Houston, TX (US); Michael Anthony Hall, Alberta (CA)

(21) Appl. No.: 16/216,991

(22) Filed: Dec. 11, 2018

(51) Int. Cl. G01V 1/28

(52) U.S. Cl. CPC G01V 1/28

(57) ABSTRACT

Spatial sampling is a key factor in determining acquisition parameters for seismic surveys. Acquiring the data to meet spatial sampling requirements for low, mid and high frequencies, by acquiring coarse, medium and fine acquisition grids respectively and layering these during processing, can result in reduced cost and/or higher quality surveys.

### RELATED APPLICATIONS

This application is a continuation of U.S. patent application Ser. No. 14/383,561, filed Sep. 7, 2014, pending, which is a National Stage entry of PCT Patent Application No. PCT/US2013/041527, filed May 17, 2013, which claims priority from U.S. Provisional Patent Application No. 61/608,629 filed Mar. 8, 2012, expired.

### BACKGROUND OF THE INVENTION

For seismic surveys, spatial sampling is one of the key factors used to determine the acquisition parameters. Source and receiver intervals are typically chosen to ensure that the maximum expected frequencies are not aliased. Surveys designed to avoid aliasing of the highest frequencies however end up oversampling the lower frequencies. Such oversampling is not typically problematic except when the effort to acquire the lower frequencies adds significantly to the cost or complexity of acquiring the survey.

### SUMMARY OF THE INVENTION

The present invention considers Vibroseis, dynamite, surface impulsive, TZ and OBC survey examples and shows that acquiring the data to meet the spatial sampling requirement for low, mid and high frequencies (by acquiring coarse, medium and fine acquisition grids respectively and layering these during processing) can result in reduced cost and/or higher quality surveys.

### DETAILED DESCRIPTION OF PREFERRED EMBODIMENTS

Low Frequencies and Spatial Sampling

Sampling the wavefield spatially is one of the most important criteria for successful seismic imaging. One of the parameters used in determining spatial sampling is the maximum frequency required from the data. For sampling the lower frequencies, the spatial sampling grid could potentially be considerably coarser. For nonlimiting example, if 25 m linear surface sampling were deemed necessary for an upper frequency of, for instance, 80 Hz in a particular survey, then a 400 m linear surface sampling would satisfy the same sampling criteria if the maximum desired frequency were to be 5 Hz. This is a ratio of 16:1 for a 2D survey and 256:1 for a 3D survey. Especially in 3D, low frequencies may be acquired using considerably lower source and receiver densities, probably about 2 orders of magnitude lower for 3D surveys. In practice, receiver line intervals are almost always much further apart than the interval required to properly sample the signal and the source intervals generally perform this function in the orthogonal direction. Depending on how the receiver line interval relates to the receiver interval along the line it may not be necessary to have a specific low frequency sensor on every receiver line. This could provide significant savings in the deployment of low frequency sensors should they be deemed to be desirable.

Vibroseis

Vibroseis is the easiest source to which to apply the concept of the present invention, as the source frequency can be tailored on an individual basis to the requirements of the survey. For nonlimiting example, if the spatial sampling requirement of the highest expected frequencies is determined to require a VP interval of 20 m, the mid-frequencies 40 m, and the low frequencies 80 m, then the sweeps could be tailored such that the high frequencies are swept every 20 m, the mid frequencies and high frequencies are swept every second VP (40 m), and the full sweep is performed (lows to highs) every fourth VP. The benefit gained by not sweeping the entire frequency range at each VP can be translated into either a cost saving (by reducing the sweep time on some VPs), or an improvement in quality, by devoting more time in sweeping the higher frequencies.

Generating very low frequencies from Vibroseis has an additional associated cost; all current methods incur extra sweep time in order to generate reasonable input energy below 5 Hz.

Dynamite Acquisition

The frequency spectrum generated by buried dynamite charges depends upon the depth of the charge below the surface, the size of the charge, and the Poisson's ratio of the formation around the charge. Shallow pattern shots are typically less expensive to acquire than deep-hole dynamite yet they can be lacking in lower frequencies due to the smaller charge sizes employed, and have an effect of a surface ghost. In this concept, a fine grid of shallow pattern holes necessary to meet the high-frequency survey sampling requirements could be supplemented with a coarser grid of shot holes designed to generate more of the very low frequencies lacking in the shallow patterns.

Hybrid Acquisition

The coarser grid comprising the low-frequency component of the signal does not need to be the same source type as the higher-frequency grid. A surface impulsive source could be used to add low frequencies attenuated by the source ghost from buried charges.

OBC/TZ Acquisition

In the shallow marine zone, the predominant seismic source is the airgun array. The requirements for generating low frequency signals diverge from the requirements for the mid and high frequencies, and could benefit from being separated into different acquisition grids. In order to generate a low frequency signal, the source array should be comprised of larger volume guns, or the guns should be discharged at a higher air pressure than standard. However, in order to maintain the same peak output as an array with smaller guns, either the total array volume will need to be increased, or the working pressure will need to be raised. Either way, the compressors will need to do significantly more work in order to supply an array tuned for low frequencies than that required for the mid and high frequencies. Again, as air supply is often the limiting factor, especially in shallow water surveys, acquiring the lower frequency components on a coarser grid will reduce the air supply requirement for the survey.

Another source for marine acquisition is the marine vibrator, and the bandwidth splitting concept can be applied. The hardware used to acquire the low frequency component of certain marine vibrators is different from that required to produce the mid and high frequencies. In such cases the low frequency source could be acquired separately, and on a coarser grid than the high frequency assembly.

It should be feasible to acquire data from low frequency sensors on a similarly spaced grid, thus enabling higher sensitivity sensors to be used economically.

The above approach would yield data on a coarser grid than the conventional acquisition grid but it should be feasible to interpolate this data back onto the same grid, as the sampling requirement for this lower frequency data is satisfied by the coarser grid.

The foregoing description of the invention is intended to be a description of preferred embodiments. Various changes in the details of the described methods can be made without departing from the intended scope of this invention.

What is claimed is:

1. A method for conducting a seismic survey or subset thereof comprising:
selecting a first acquisition grid for acquiring a first set of seismic data;
deploying sensors for acquiring the first set of seismic data in the first acquisition grid, the first acquisition grid corresponding to a first frequency range;
selecting at least a second acquisition grid for acquiring at least a second set of seismic data;
deploying sensors for acquiring the at least a second set of data in the second acquisition grid, the second acquisition grid corresponding to at least a second frequency range;
wherein the at least a second frequency range is substantially different from the first frequency range, and wherein the first acquisition grid and the at least a second acquisition grid are different and selected to provide complementary spatial sampling in the first frequency range and the at least a second frequency range.

2. The method of claim 1, further comprising the step of compositing the first set of seismic data and the at least a second set of seismic data.

3. The method of claim 2, wherein the step of compositing the first set of seismic data and the at least a second set of seismic data comprises layering the first set of seismic data and the at least a second set of seismic data.

4. The method of claim 1, wherein the first frequency range and the at least a second frequency range are determined from a seismic source.

5. The method of claim 4, wherein the seismic source is selected from the group consisting of vibroseis, dynamite, surface impulsive source, airgun, marine vibrator, and combinations thereof.

6. The method of claim 5, wherein the seismic source for the first frequency range is the same type as the seismic source for the at least a second frequency range.

7. The method of claim 6, wherein the seismic source for the first frequency range is implemented differently than the seismic source for the at least a second frequency range.

8. The method of claim 7, wherein the seismic source is a plurality of airguns deployed in an airgun array, wherein the airgun array for the first frequency range is selected for a predominantly low frequency output and the airgun array for the at least a second frequency range is selected for a predominantly high frequency output.

9. The method of claim 8, wherein the plurality of airguns for the airgun array for the first frequency range are larger volume airguns than the plurality of airguns for the airgun array for the at least a second frequency range.

10. The method of claim 8, wherein the plurality of airguns for the airgun array for the first frequency range are implemented at a higher pressure than the plurality of airguns for the airgun array for the at least a second frequency range.

11. The method of claim 8, wherein the airgun array for the first frequency range is in a coarser grid than the airgun array for the at least a second frequency range.

12. The method of claim 5, wherein the seismic source for the first frequency range is different from the seismic source for the at least a second frequency range.

13. The method of claim 1, wherein the first frequency range and the at least a second frequency range are determined by a seismic receiver.

14. The method of claim 1, wherein the first frequency range and the at least a second frequency range are each selected from low, mid and high frequencies ranges.

15. The method of claim 14, wherein the first frequency range is a high frequency range and the first acquisition grid is a fine grid, a second frequency range is a mid frequency range and a second acquisition grid is a medium grid, and a third frequency range is a low frequency range and a third acquisition grid is a coarse grid.

16. The method of claim 5, wherein the seismic source is vibroseis with a predetermined VP interval, the first frequency range is a high frequency range with seismic data acquired at each VP interval, a second frequency range is a mid frequency range with seismic data acquired at each second VP interval, and a third frequency range is a low frequency range with seismic data acquired at each fourth VP interval.

17. The method of claim 5, wherein the seismic source is dynamite, the first frequency range is a high frequency range with seismic data acquired from a fine grid of shallow pattern shots, and the at least a second frequency range is a low frequency range with seismic data acquired from a coarse grid of deep pattern shots.
